(19) United States
(12) Patent Application Publication
(10) Pub. No.: US 2010/0076853 A1
(43) Pub. Date: Mar. 25, 2010

(54) METHOD AND SYSTEM FOR ORDERING AND SUPPLYING GOODS AND SERVICES VIA A CELLULAR PHONE

(76) Inventor: Alon Schwarz, Kfar Saba (IL)

Correspondence Address: HENRY M. SINAI;(IP-PARTNERSHIP), P.O. BOX 669, RAANANA, 43350, IL

(21) Appl. No.: 12/309,113

(22) PCT Filed: Jul. 8, 2007
(86) PCT No.: PCT/IL2007/000853

§ 371 Date: Jan. 7, 2009

Related U.S. Application Data
(60) Provisional application No. 60/818,977, filed on Jul. 7, 2006.
(60) Provisional application No. 60/876,988, filed on Dec. 26, 2006.

(51) Int. Cl. G06Q 30/00; G01C 21/00; G06Q 50/00; G06Q 10/00; G06Q 20/00; H04W 4/14

(52) U.S. Cl. 705/15; 701/300; 705/26; 705/27; 705/34; 455/466

(57) ABSTRACT

A method and a system for ordering and supplying goods and services is provided. The method includes the steps of an end user sending a coded SMS (Short Messaging System) message using a specially created syntax from a cellular device to an intermediary computer, which is configured to identify the supplier of goods being ordered from the coded SMS message and route the received message to the identified supplier of goods. The coded SMS message may also include unique identifiers for identifying goods being ordered, menu or catalog identifier codes, identifiers to identify the method of payment and the method of delivery.

### FIELD OF THE INVENTION

The present invention relates to a method for ordering and purchasing goods and services using the Short Messaging System (SMS) of cellular telephones or other text based command-line capable, online communications application or device

### BACKGROUND OF THE INVENTION

Cellular communications growth in the past few years has been phenomenal. The convenience of the cellular phone has led to the cellular phone being used for other purposes such as a camera, video and music player. One of the major uses of the cellular phone is the use of Short Messaging System (SMS) for sending text messages. International Application WO 03/084252 describes an interactive messaging system which combines the use of short text messages with a database and messaging system.

SMS is now used for purchasing ring tones and similar virtual products. This use of SMS is generally limited to a non-flexible system for ordering products.

There is thus a need to provide a flexible service using a simple text language syntax based on SMS text messaging for ordering or inquiring about items. There is also a need to enable a merchant wishing to supply goods and services to register as a provider of goods for customers to order using SMS text language from their cell phones.

### SUMMARY OF THE INVENTION

The present invention relates to the use of SMS for initiating an automated or semi-automated process as part of a service for ordering or inquiring about items from a catalog or menu. The catalog and menu may be paper or electronic format or a televised advertisement and not necessarily aggregated as part of the system or database. A simple coded SMS message may be sent from the cellular device of the customer to a merchant via an intermediary computer operating the service (“Lingolines™”, for example,) which routes the message to the merchant. The coded message may contain the catalog/menu unique identifier and a list which may include several items designated by item numbers specific to the designated menu/catalog, a call-back indication and additional customer details, for example.

A simple coded SMS message may be sent from the cellular device of the customer to a merchant via an intermediary computer. The coded message may contain the order which includes a merchant's identifying code, a detailed list of items from a designated catalog or menu, call-back indication and additional customer details, for example. The present invention also allows merchants, advertisers and business owners to enable core business process automation with little or no effort, by simply registering for a web activated service.

The present invention has advantages over existing systems such as voice-calls or using a web based shopping cart, since it is easier and faster to send a one line text message.

For the merchants, filling a quick web registration wizard and operating a web based management interface (application specific), is all it takes to integrate key business process automation applications.

There is thus provided a method and a system for ordering goods via a cellular phone. In accordance with an embodiment of the present invention, the system includes at least one cellular device for sending a coded SMS (Short Messaging System) message and an intermediary computer which receives the message and routes the received message to a supplier of goods. The coded SMS message is configured to include at least one of group of identifiers includes an identifier for identifying the supplier of goods to whom the message is directed.

In accordance with an embodiment of the present invention, there is also provided a method, which includes the steps of:

an end user sending a coded SMS (Short Messaging System) message from a cellular device to an intermediary computer;

the intermediary computer configured to identify the supplier of goods being ordered from the coded SMS message; and

the intermediary computer routing the received message to the identified supplier of goods.

Furthermore, in accordance with an embodiment of the present invention, the coded SMS message may include an identifier identifying the supplier of goods to whom the message is directed. Furthermore, the coded SMS message may further include at least one unique identifier, the identifier identifying a specific item being ordered.

Furthermore, in accordance with an embodiment of the present invention, the coded SMS message may further include at least one of a group of identifiers including a menu or catalog identifier code, identifiers to identify the method of payment, method of delivery, the customer's dietary constraints and additional text information.

Furthermore, in accordance with an embodiment of the present invention, the supplier of goods is a restaurant and the goods being ordered comprise a list of menu items.

Furthermore, in accordance with an embodiment of the present invention, the method may further includes the steps of recognizing the sender of the coded SMS message; and if the supplier of goods is known to the intermediary computer, sending a return SMS message to the sender containing a URL (Uniform Resource Locator) with an embedded link in which an identifying code of the user's caller ID is also embedded.

Furthermore, in accordance with an embodiment of the present invention, the method may further include the step of registering the end user and the step of the intermediary computer authenticating the identity of the end user and sending a SMS containing an ID code embedded in an URL, to the end user.

Furthermore, in accordance with an embodiment of the present invention, the method may further include the steps of:

the intermediary computer opening a WAP or web session with the end user to the end user containing a list of options for receiving the goods being ordered including at least one delivery address previously registered by the intermediary computer, option of entering at least one new delivery address and option of picking up the ordered goods; and

advising the supplier of goods of the delivery option selected.

Furthermore, in accordance with an embodiment of the present invention, the method may further include the steps of the supplier of goods opens a WAP/web session includes at least one item which may be ordered from a selection of items in at least one menu; and the end user ordering the at least one item from the supplier of goods.

Furthermore, in accordance with an embodiment of the present invention, the method may further include the steps of:

the end user adding to, deleting or replacing items being ordered;

selecting a method of payment from one of a group of methods including payment by cash and payment by credit; and

the supplier of goods processing the order and confirming the order and delivery details to the end user by SMS message to the end user.

Furthermore, in accordance with an embodiment of the present invention, the method may further include the step of the intermediary computer initiating a query to determine if the user address falls within the delivery zone for the specific restaurant. In addition, if the supplier of goods selected does not deliver to the address requested, the intermediary computer may advise the end user of alternative suppliers of goods who do deliver to the address selected.

Furthermore, in accordance with an embodiment of the present invention, the method may further include the step of making a cartographic type query to the supplier of goods via a GIS system to determine the delivery zone of the supplier of goods.

Furthermore, in accordance with an embodiment of the present invention, the confirmation may include an indication of the delivery time.

Additionally, in accordance with an alternative embodiment of the method of the present invention, the supplier of goods may be one of a group taxi services including a taxi dispatcher and at least one taxi driver, and the goods being ordered may comprise a request for a taxi. In this embodiment, the coded SMS message may be further configured to include an identifier identifying the address and the time of the requested taxi ride.

Furthermore, in accordance with an embodiment of the present invention, the method may further include the steps of:

the intermediary computer searching a database to determine which taxis are within range of the address;

broadcasting a message to the taxis within range of the address, the message containing the address and time of the requested taxi pick up; and

confirming the order to the taxi accepting the taxi pick up.

Furthermore, in accordance with an embodiment of the present invention, the method may further include the step of advising the end user of the time of the pick up and the contact details of the driver.

Furthermore, in accordance with an embodiment of the present invention, the intermediary computer may be configured to append additional details to the routed message. The additional details may include at least one of a group including the contact details of the message initiator and order number assigned by the intermediary computer.

Furthermore, in accordance with an embodiment of the present invention, the received message may be sent to the merchant to one of group of devices including a PC or PDA, via an internet capable dedicated application, by fax, SMS message to a cellular device and email.

Furthermore, in accordance with an embodiment of the present invention, the intermediary computer may include a database containing details of taxi cabs. The intermediary computer may be configured to broadcast a message to taxis within range of the address, the message containing the address and time of the requested taxi pick up and wherein the intermediary computer is configured to confirm the order to the taxi accepting the taxi pick up.

Additionally, in accordance with an embodiment of the present invention, there is provided a method for supplying goods and services. The method may include the steps of:

assigning an identifier identifying the supplier of goods and services;

creating a syntax for use with SMS (Short Messaging System) the syntax may include at least the supplier identifier; and

an end user ordering at least one item utilizing the syntax via a SMS message to the supplier of goods.

Furthermore, in accordance with an embodiment of the present invention, the method may further include the step of assigning a unique code for each of a group of items being offered for sale by the supplier. The syntax may include at least one unique item code associated with the supplier.

Furthermore, in accordance with an embodiment of the present invention, the method may include the step of assigning payment identifiers to identify the method of payment and delivery identifiers to identify the method of delivery. The syntax may include one of the payment identifiers and one of the delivery identifiers.

Furthermore, in accordance with an embodiment of the present invention, the method may include the step of the supplier sending a SMS message to an end user, the SMS message may include at least the syntax for ordering from the supplier.

Furthermore, in accordance with an embodiment of the present invention, the payment identifiers may include any of a group of methods including payment by cash and payment by credit.

Furthermore, in accordance with an embodiment of the present invention, the method may include the step of the supplier processing the order and confirming the order and delivery details to the end user by SMS message to the end user via an intermediary computer.

Additionally, in accordance with an embodiment of the present invention, there is provided a method for supplying goods and services. The method may include the steps of:

a merchant registering with an intermediary computer, the intermediary computer being in communication with a plurality of end users; and

preparing a customized explanatory label may include at least an identifier identifying the merchant, at least one item being supplied by the merchant and an identifier for the at least one item.

Furthermore, in accordance with an embodiment of the present invention, the customized explanatory label may include an indication of the payment methods accepted by the merchant, the payment methods may include any of a group including payment by credit card and cash. In addition, the customized explanatory label may further include an indication of the type of delivery and collection available.

Furthermore, in accordance with an embodiment of the present invention, the method may include the step of the merchant selecting a method of being billed by the intermediary computer, the method may include one of group of methods including payment by credit card, check and paypal™. The delivery location may include a coded field indicating a pre-registered address.

Furthermore, in accordance with an embodiment of the present invention, the step of registering may include the steps of entering the merchant's name, merchant identifying code and password; and entering the merchant's contact details.

Furthermore, in accordance with an embodiment of the present invention, the method may include the step of registering and may further include the step of entering the type of computer device used by the merchant for managing incoming orders.

### BRIEF DESCRIPTION OF THE DRAWINGS

The present invention will be understood and appreciated more fully from the following detailed description taken in conjunction with the appended drawings in which:

FIG. 1 is a flow chart illustration of a method for ordering goods via a cellular phone according to an embodiment of the present invention;

FIG. 2 illustrates a sample menu containing a sample label illustrating the ordering procedure for a merchant's product for use with the method and system of FIG. 1;

FIGS. 2A-2D are sample labels illustrating alternative label shapes for use with the method and system of FIG. 1;

FIGS. 3A and 3B are schematic flow chart illustrations of a method for ordering goods using SMS-triggered cellular Internet menu, according to an embodiment of the present invention;

FIG. 4 is a flow chart illustration of a method for a merchant to service an order initiated by a customer according to the method of FIGS. 3A and 3B; and 1

FIG. 5 is a map illustrating the boundaries of the merchant's delivery zone;

FIGS. 6A-6I illustrate a web based wizard for producing a label in accordance with FIGS. 2 and 2A-2D, for use by a merchant wishing to supply goods in accordance with the method of FIG. 1;

FIG. 7 is a flow chart illustration of a callback advertising application, according to an embodiment of the present invention;

FIG. 8 is a sample of an advertising label appearing on a television advert for use with the method of FIG. 7;

FIG. 9 is an exemplary web management interface of a restaurant menu used with the method of FIGS. 1, 3A and 3B;

FIG. 10 is an illustration of a PDA management interface for use in managing stock with the method of FIGS. 1, 3A and 3B;

FIG. 11 is a flow chart illustration of a method for ordering taxi in accordance with an embodiment of the present invention;

FIG. 12 is a visual display of a touch screen for use by a taxi station with the embodiment of FIG. 12;

FIG. 13 is a flow chart illustration of an alternative method for ordering taxi in accordance with an embodiment of the present invention; and

FIG. 14 is a flow chart illustration of an alternative method for ordering taxi in accordance with an embodiment of the present invention.

### DESCRIPTION OF THE PRESENT INVENTION

The present invention relates to the use of SMS for initiating an automated or semi-automated process as part of a service for ordering or inquiring about items from a catalog or menu or for ordering a service, such as a taxi. The coded message may contain the catalog/menu unique identifier or a merchant ID and a list which may include several items designated by item numbers specific to the designated menu/catalog, a call-back indication and additional customer details, for example.

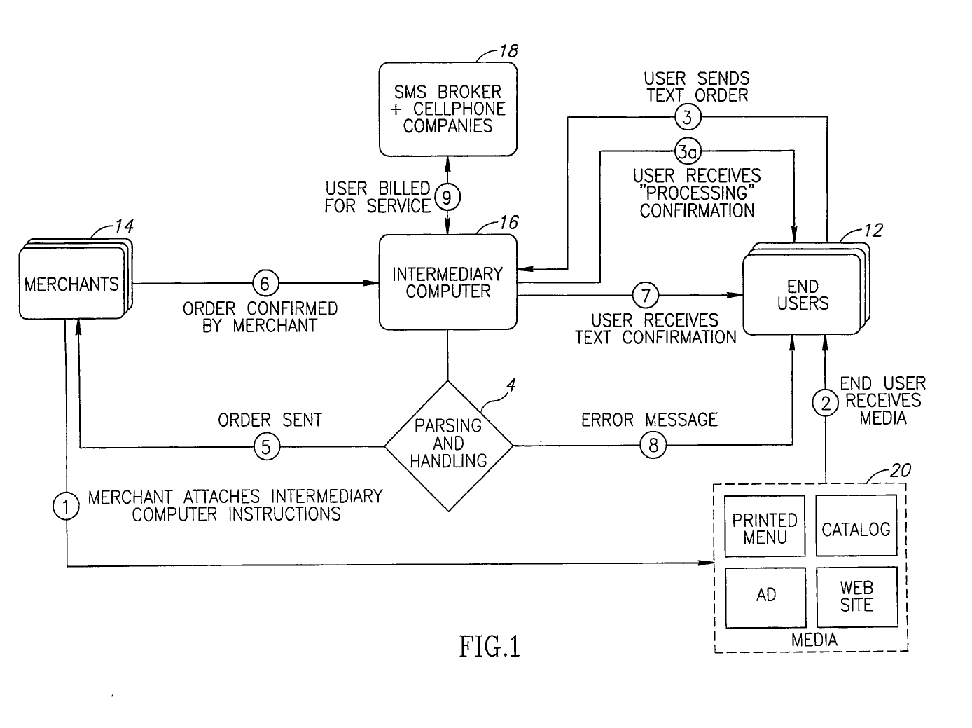

The system, described hereinbelow with reference to FIG. 1, includes a cellular device sending the SMS and an intermediary computer which routes the message to a specific merchant who is the catalog/menu vendor. The merchant's ID or menu/catalog identifier appears as part of the SMS coded message originally received from the customer.

The customers messages that are turned into ‘orders’ by the intermediary computer program are routed or forwarded to merchants/sellers/catalog vendors/advertisers via web interface (merchant's account) or any specific internet capable client application/device, or if such not available by SMS, fax or email.

The message from the intermediary computer to menu/catalog owners includes the information of the catalog items ordered/inquired-upon and the contact details of the original message initiator (the customer's contact details and address may be pre-registered in the system and added to the ‘order’ by the intermediary computer).

The intermediary computer recognizes the customer by the caller's I.D. number and thus the seller/merchant receives the forwarded/routed order which includes all the details originally encoded into the customer's SMS and in addition any information which may be “added” by intermediary computer such as the pre-registered customers contact and personal information.

Orders may include any or all of the following details:
order number (unique identification assigned by intermediary computer)
menu/catalog identifier code
name of customer
customer address
customer phone number
customer email
items ordered
delivery/pickup indication
type of transaction cash/credit
customer's dietary constraints (for example: allergies/no MSG)
credit card information (optional)
free text

The merchant may receive the information via web-site (on PC or PDA), or via internet capable dedicated application or appliance or if unavailable by fax or SMS-messages or email,

If there is a “buy” process rather than an “inquiry only/call back” process, the seller approves the order by any of the available interfaces, and the customer then receives a conformation after this approval, by a reply SMS and optional email-via the intermediary computer. All SMS messages are listed to a database after passing through intermediary computer.

The seller can also manage a list of “out of stock items” and “back in stock items” by using the merchant web interface (via merchants account) or internet connected dedicated appliance or optionally by a simple coded SMS messages with +/−item numbers, sent to the central intermediary computer from the seller's/merchant's recognized number.

The method for either ordering/buying certain menu/catalog items (as detailed above) may also be applied as a second application for collecting a list of “interested potential customers/potential leads” for the merchant to get back to (in the second case without any purchase/deal/order happening as part of the SMS sent). An example of a means for “call back” rather than “ordering/buying”: a television commercial or newspaper advertisement can include a merchant number or advertisement/TV-commercial code word, and the “customer” can SMS the central intermediary server that number/code thus indicating he is interested in the particular add. The customer can also add a “time value” into the SMS request sent, thus indicating what time he would prefer to be called back at. The customer information is passed on to the advertiser for initiating a ‘call back’ from the advertiser's call center to the potential customer without an actual product being ordered. The advantages of this method are that many potential customers can show interest in an advertisement and easily transfer their details to the seller so that he can get back to the potential customers. Thus, a “one way” advertisement campaign may turn into a “two way” campaign (automated call back list). The advantages over a telephone number included as part of the advertisement are that the system can handle many more requests at peak times (when commercial is broadcast) than human call centers can handle and in addition, the “customer” doesn't have to wait for his call to be answered and doesn't have to leave a message (human voice messages are not machine interpretable). In addition SMS user-experience doesn't require full attention and thus in the case of television advertisements the program watched can be given attention to and not missed because SMS sending doesn't require much attention and call back may happen at a later time. Also SMS is often much cheaper than placing a voice call to a call center by the end user. In the call back application example, the merchants will be charged a fix service price and a “per lead” price for each customer that requests call back rather than charging the end user premium SMS charges. Users will probably only pay regular SMS rates (no premium charges or reverse billing model in call back application).

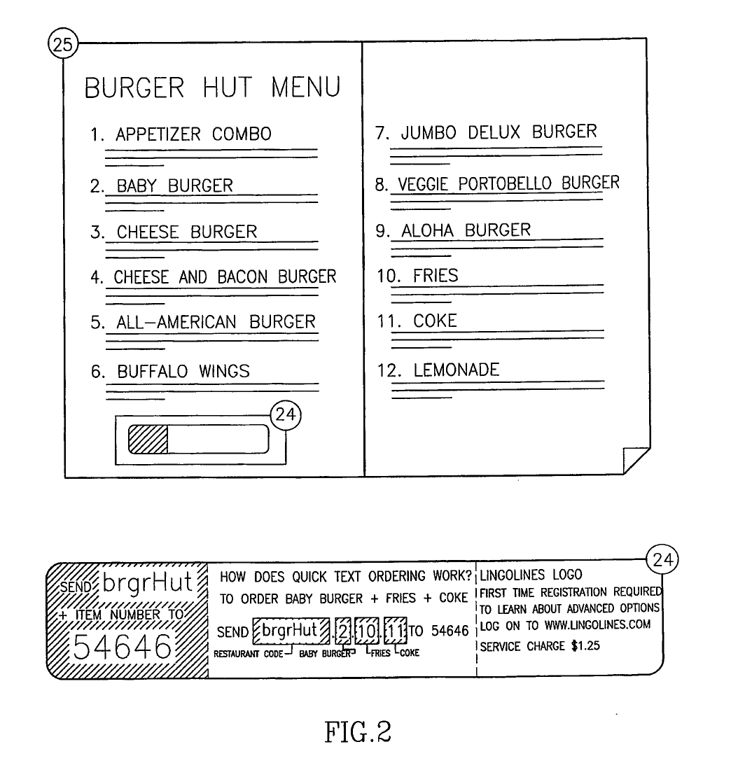

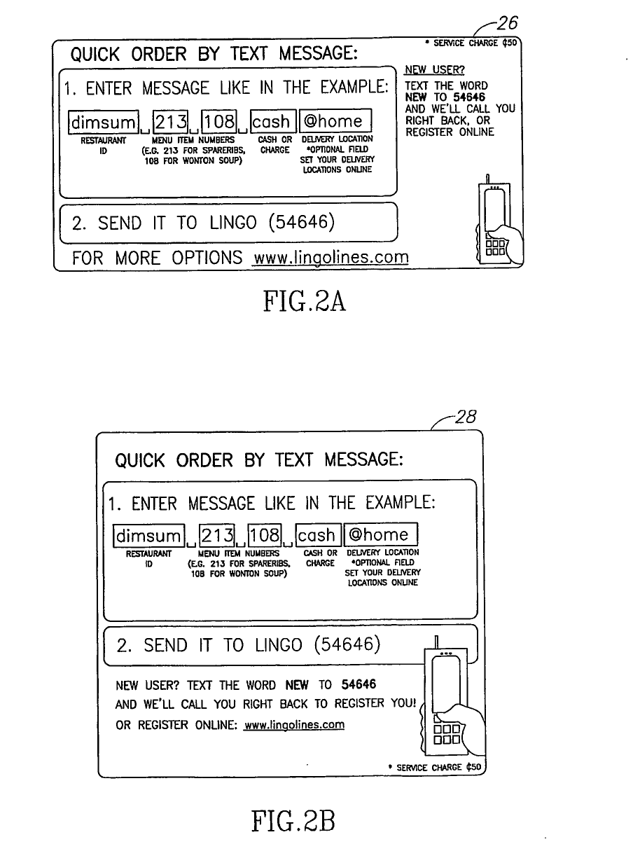

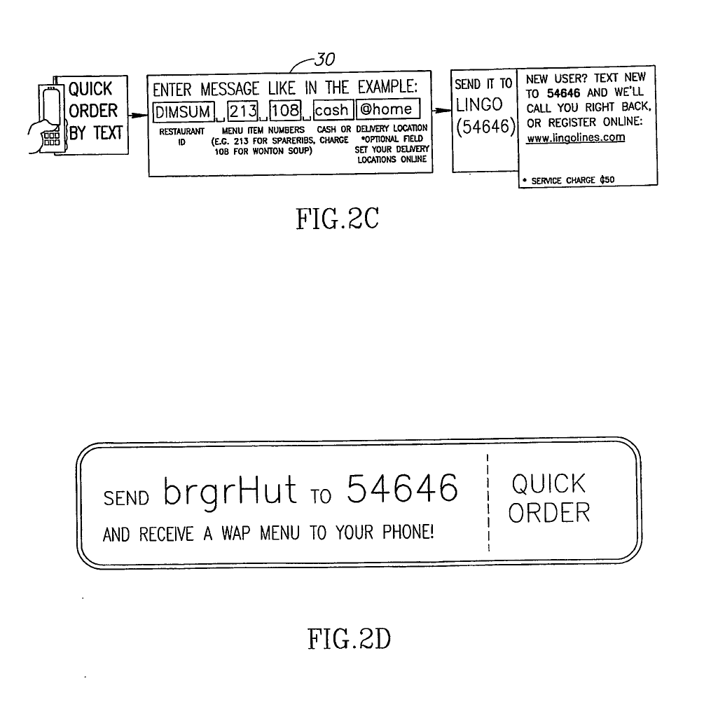

Reference is now made to FIGS. 1 and 2A-2B. FIG. 1 is a flow chart illustration of the system and method, generally designated 10, for ordering goods via a cellular phone, in accordance with an embodiment of the invention.

Briefly, the system and method 10 of FIG. 1 interconnects the end user 12 ordering an item with the merchant 14 handling the ordered item via an intermediary service computer 16 operating the service (“Lingolines”) which routes messages between the merchant 14 and the user 12. The system 10 further interconnects with the cellular phone company 18 through whom communications between the parties is made. The merchant 14 may promote the items on offer via any suitable media outlet 20, such as a printed menu, catalog, advert or web site, for example.

The method for buying (or ordering) one or more items may be described, at a high level, as follows:

The user 12 obtains details of the menu/catalog items from the media 20 (arrow 2) and sends a SMS text order using his cell phone to the service computer 16 (arrow 3). The service computer 16 parses the message (query box 4) and forwards the order to the merchant 14 (arrow 5). The service computer 16 also sends a confirmation message to the user 12 that his order has been received (arrow 3a)

The merchant 14 confirms the order to the service computer 16 (arrow 6), which advises the user 12 that the order has been approved (arrow 7). In the event of an error in the text message sent, an error message is sent to the user 12 (arrow 8). The billing for the text ordering service itself may be made through the cell phone company in case of end-users being charged (arrow 9)

In another embodiment, billing may be through credit cards between the service company and merchants. Billing for the actual goods may alternatively be settled by cash or by credit card directly between the merchant and customer.

FIG. 2 illustrates a sample menu 25 containing a label 24. In this example, menu is associated with a restaurant called “Burger Hut”, and it is in a country where the service provider's (“Lingolines™”, for example) contact number short code is 54646.

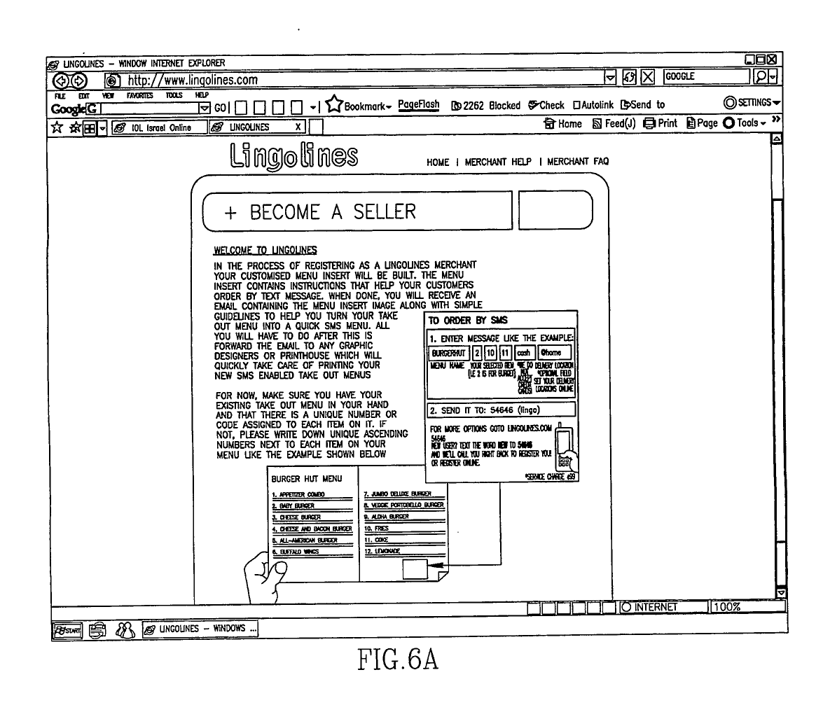

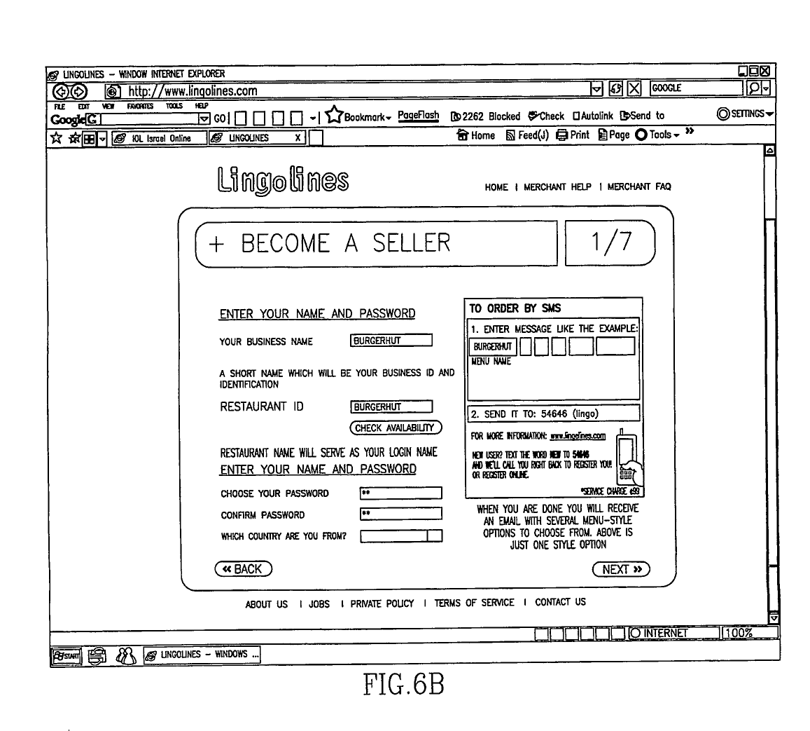

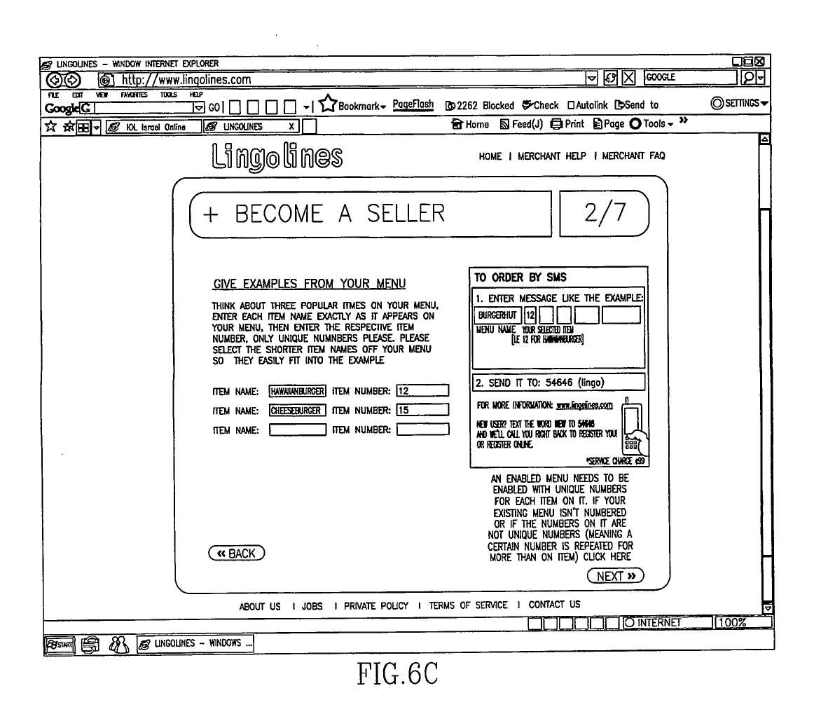

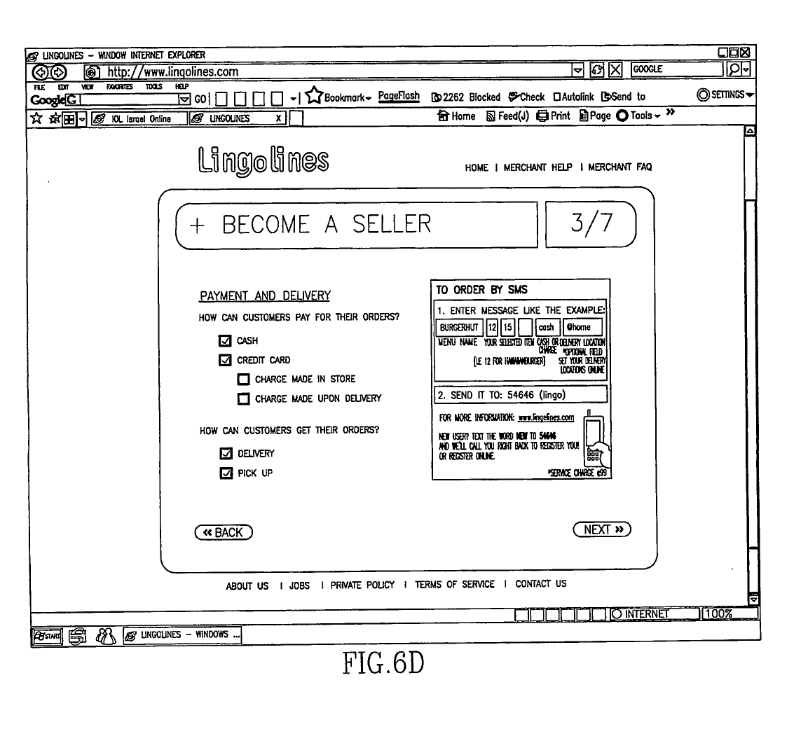

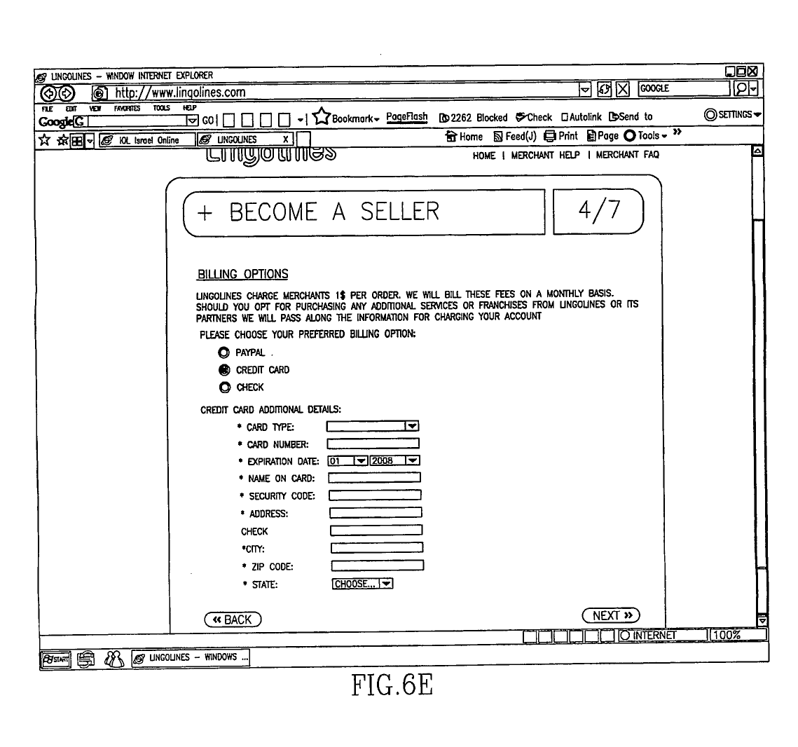

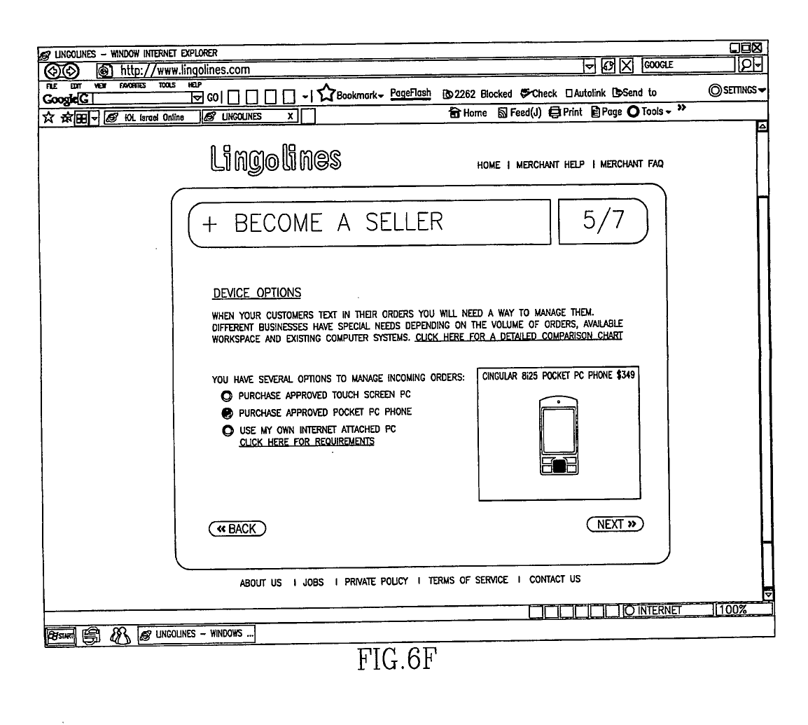

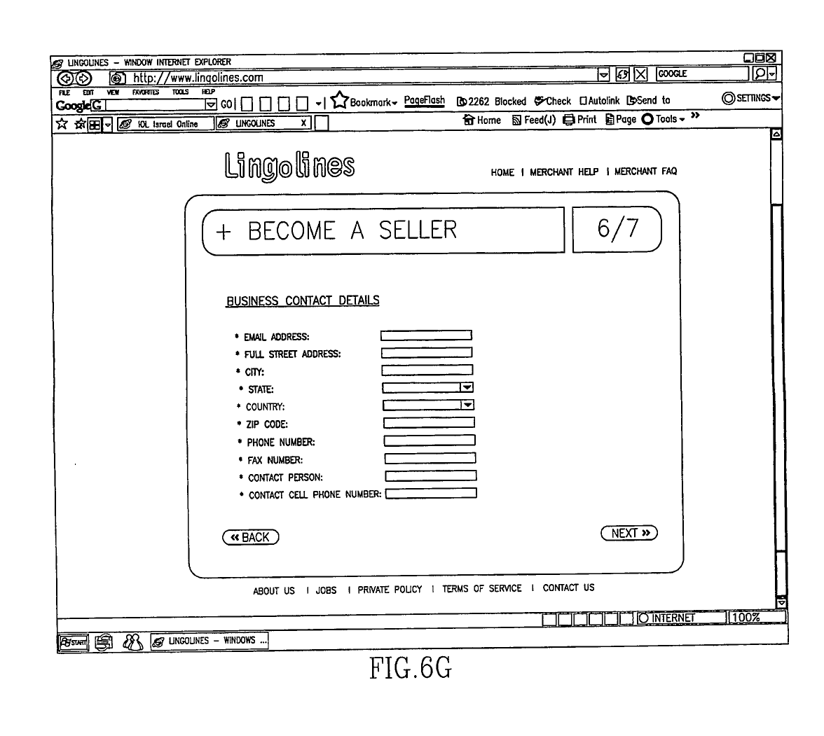

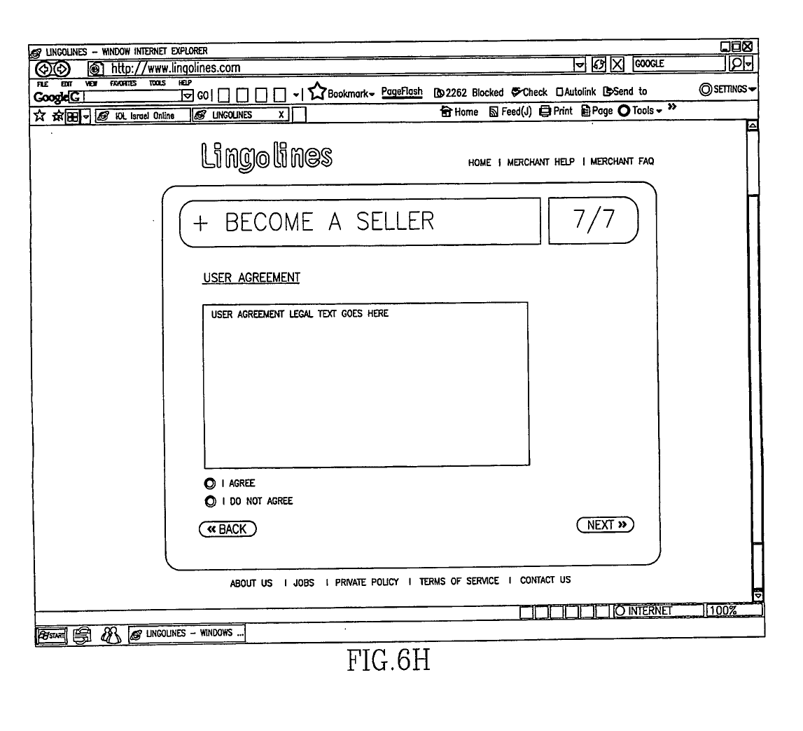

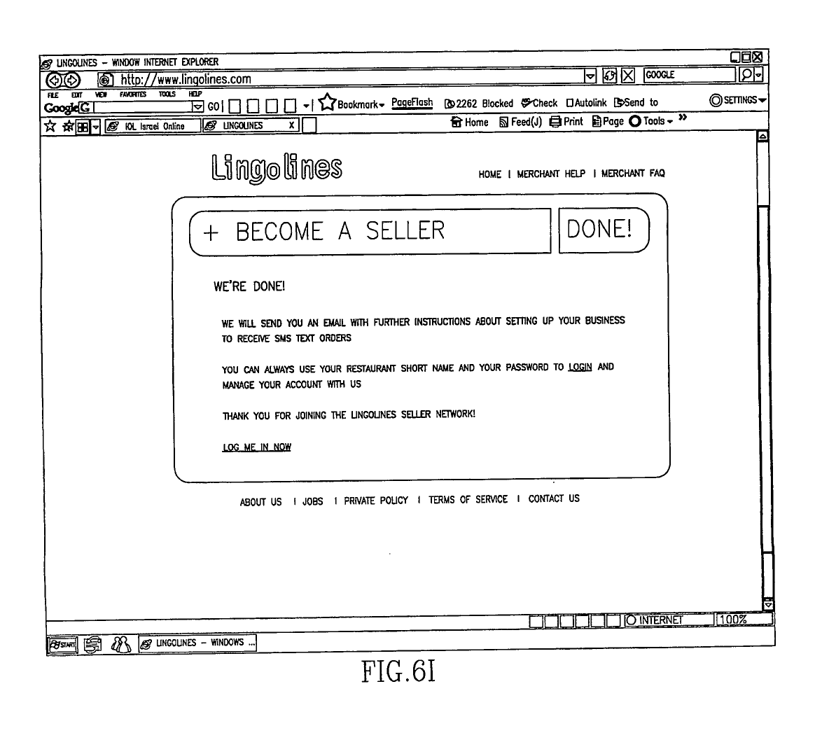

The sample label 24 illustrates the ordering procedure for a merchant's product list. The label may be auto-produced by the merchant using a web-based wizard (described hereinbelow with reference to FIGS. 6A-6I). In the example of label 24, the text message to be sent comprises four elements; restaurant code (“brgrHut”) followed by three number codes (2, 10, 11) for the items to be ordered. Code 2 refers to a “baby burger” (menu item 2), code 10 refers to “fries” (menu item 10) and code 11 refers to “coke” (menu item 11).

FIGS. 2A-2C are three further illustrative sample labels, referenced 26, 28 and 30, respectively, showing additional graphical options for use with the method and system of FIG. 1. The merchant may attach any one of them to his product list, menu or catalog. He has several shapes to choose from and they may be produced using the online wizard. The wizard is auto customized in content as well as shape.

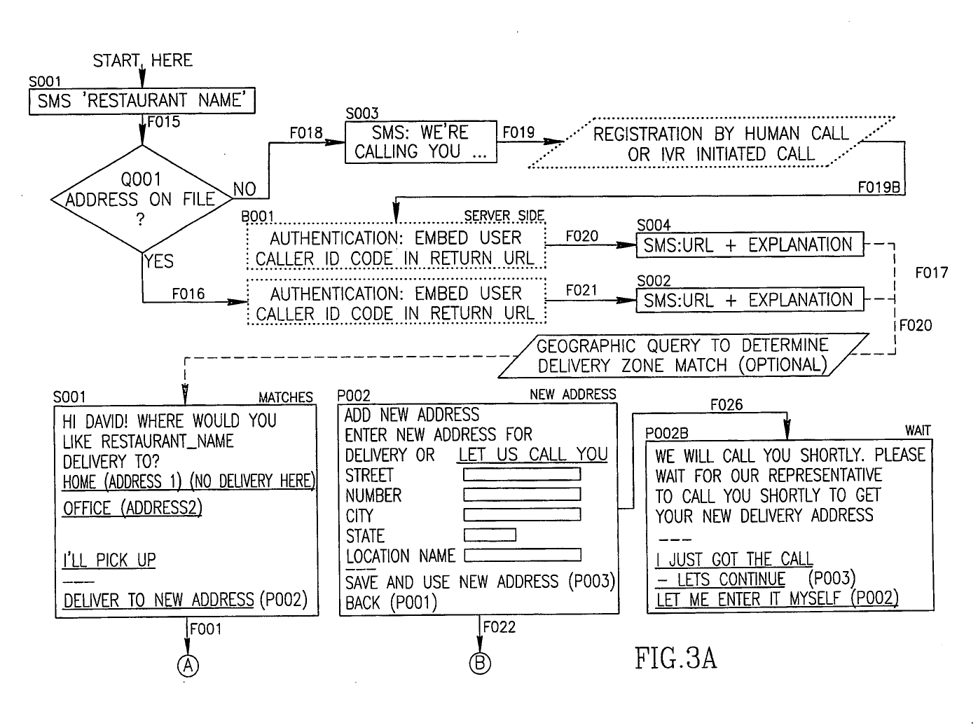

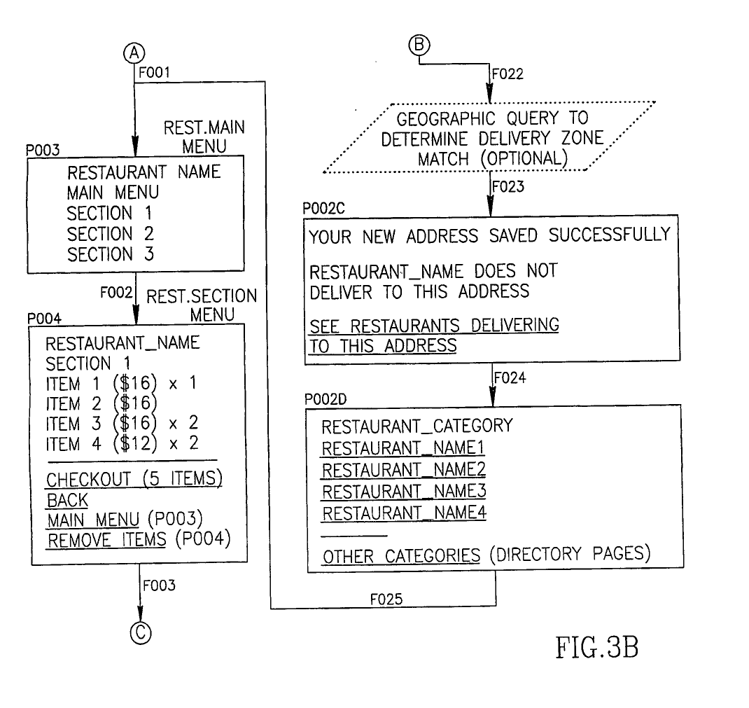

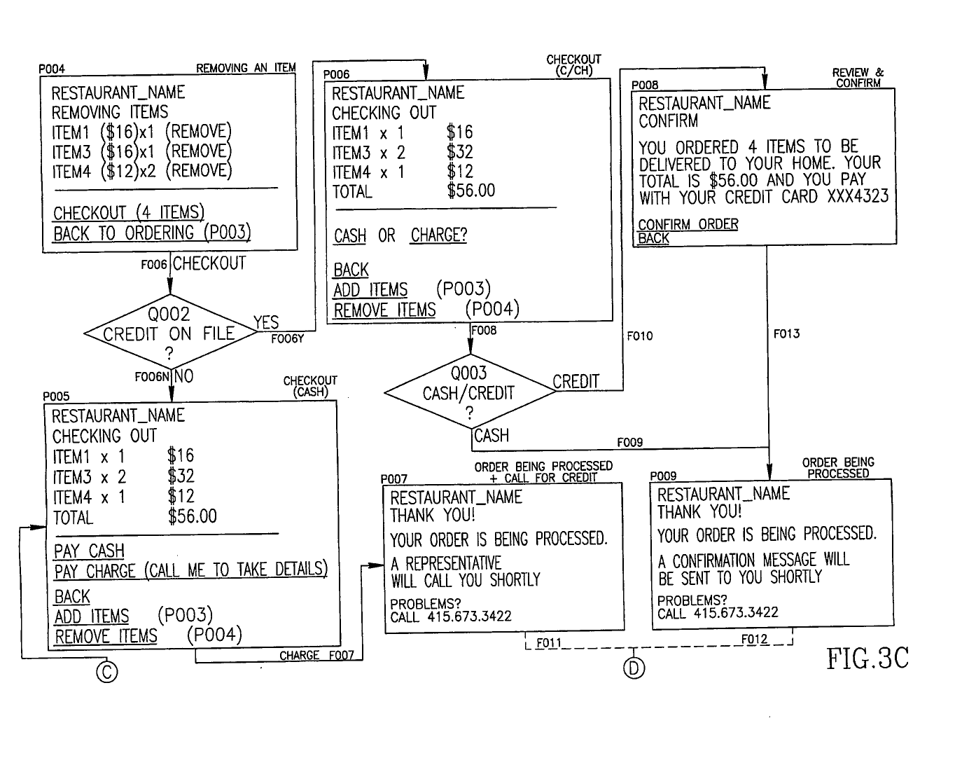

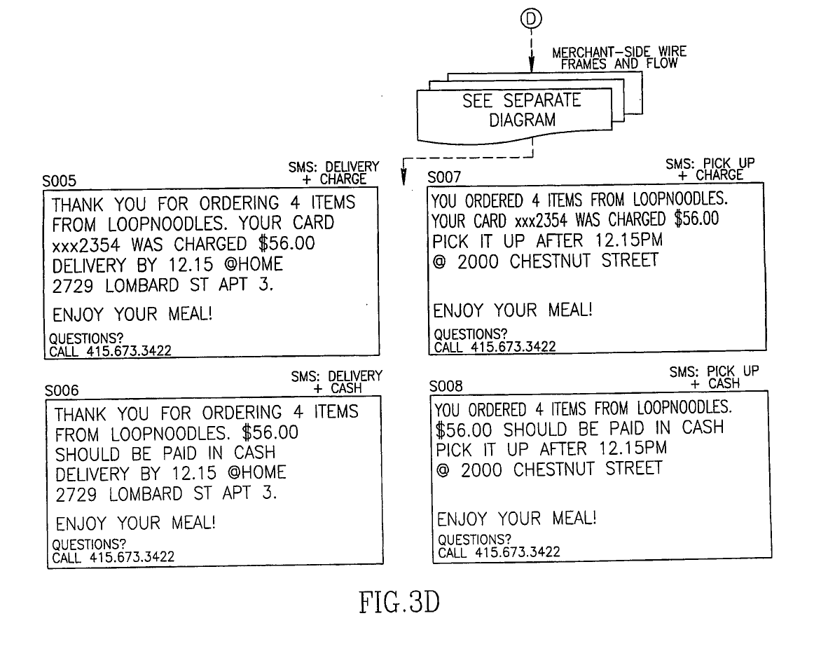

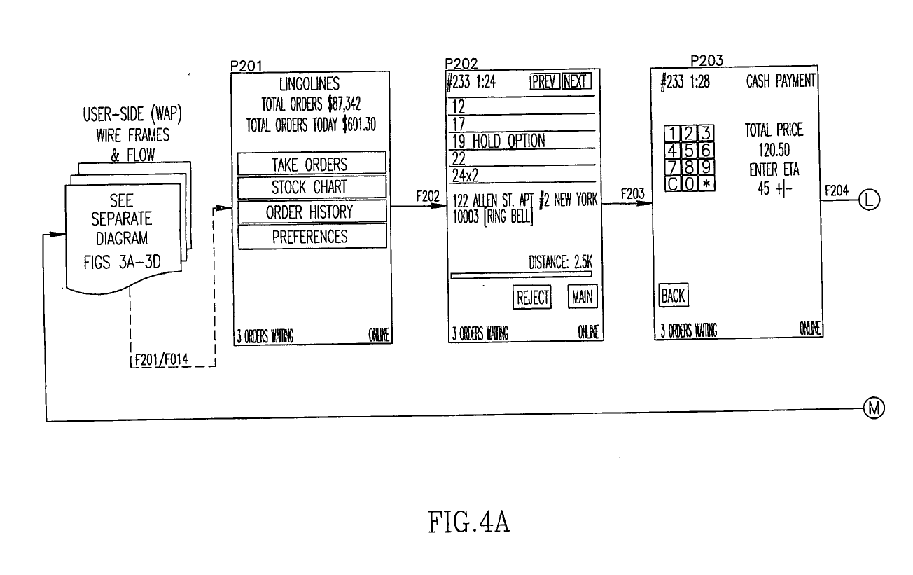

FIG. 2D illustrates a further exemplary label, referenced 32, used for advertising the SMS-WAP ordering method as described in FIGS. 3A and 3B (hereinbelow). This label may be placed on a pizza carton, made into a magnet for putting on the fridge, used in a TV commercial, or on a bill board, for example, or on any other media type that doesn't accommodate a full list of items or a full catalog/menu. The label may also be auto produced and defined by the merchant using the online wizard, and is suitable for sending by email.

In addition a ‘combo insert’ or label which indicates to the end user that he can either send the ‘restaurant name in one word and get a WAP menu’, or just send a ‘pure-SMS with the whole order in text’, —are further non-limiting examples of labels which may be used with system and method of FIGS. 1, 3A and 3B. For example a ‘combo’ label may be used.

Initially, a merchant 14 who wants to join an automation service completes a web based wizard which registers the merchant in the database of service company 16 and auto-produces a customized sticker/image, such as one of the labels 24, 26, 28, 30 or 32, for example, containing details to be attached to media outlet 20 (electronic or paper menu/catalog/advertisement, for example). FIGS. 6A-6I (described in detail hereinbelow), illustrate a web based wizard, for use by a merchant 14 wishing to register with service computer (such as “Lingolines™”, for example) 16 wishing to supply goods through the system 10.

The system and method 10 may now be described in further detail with reference to FIG. 1. The end user (potential customer) 12 may receive the media with the information through any existing media distribution channel 20. For example, the user 12 may use the label appearing on a menu 25, such as illustrated in FIG. 2B, for example.

The end user 12 sends an SMS text message coded as instructed by the merchant's sticker/advertisement on the image (arrow step 3). The message is routed from cell company/SMS broker 18 to the service company's (such as “Lingolines™”) computer 16 and optionally billed via reverse SMS premium billing service. Alternatively, billing may be by credit card if user cell phone company does not support reverse billing or if user uses email or enters text line order via the web as an alternate interface to SMS or if user has chosen to be billed for the service itself directly by the service company (“Lingolines™”) and not by cell phone company. In last case mentioned, the end-user would pay regular SMS charges rather than premium, and pay separately for order service directly to the service company (such as “Lingolines™”).

In arrow step 4, parsing and processing is carried out by the intermediary service computer 16. In the exemplary application where a customer 12 wishes to purchase an item, the steps may be as follows:
Identification of user by caller ID→
if user is registered with “Lingolines™”→
check if merchant is recognized by the merchant id or short name received in users text message→
check if merchant is currently logged on+check if time is within opening hours of merchant→
check if items ordered are not pre-designated “out of stock” by merchant*→
check if merchant and user are within pickup/delivery range by calculating address distance range, or check if customer address falls within a predefined delivery zone marked as a polygon on an electronic map via third party web service such a Google Maps™-polygons-API*→
check if merchant has not designated user as “prohibited user”→
delivery or pickup status check→
check if any advanced options such as credit-card pay for deal″/credit card pay for order fulfillment*/delayed time delivery* are available with merchant if requested by user.
indicates optional features

If all the system checks in step (query box) 4 are verified, the end-user details and user SMS-text order information are added and routed/forwarded as an order to the merchant via web interface (arrow step 5). If web interface not available, the details may be sent by other means such as, to a dedicated cell appliance, SMS and fax, for example.

If there is an error or a query a message may be sent back to the customer (arrow step 8).

In arrow step 6, the merchant may confirm or cancel the order via online web order management screen or web enabled appliance, or by any other means including but not limited to SMS, voice and touch dial telephoning.

Merchant automated approval of order may be problematic with fax, since fax is not an online computerized type interface. This issue could be solved for example by the merchant calling a touch-tone approval system and entering the ‘order number’ printed on the order received by fax, or by sending an approval SMS message to a special, service company (such as, “Lingolines™”) merchant-approval short number with the ‘order-number’ as the SMS text.

A maximum time for order approval by merchant may be set by the system. If no ‘time-out’ occurred, the service company (“Lingolines™”) forwards message by text message containing order approval to the end user (customer) 12 (arrow step 7).

If “time out” occurred, the merchant will get a cancellation for order and user will get a timed-out error and a text message to try again a bit later. Crime out' arrow not shown in flow chart).

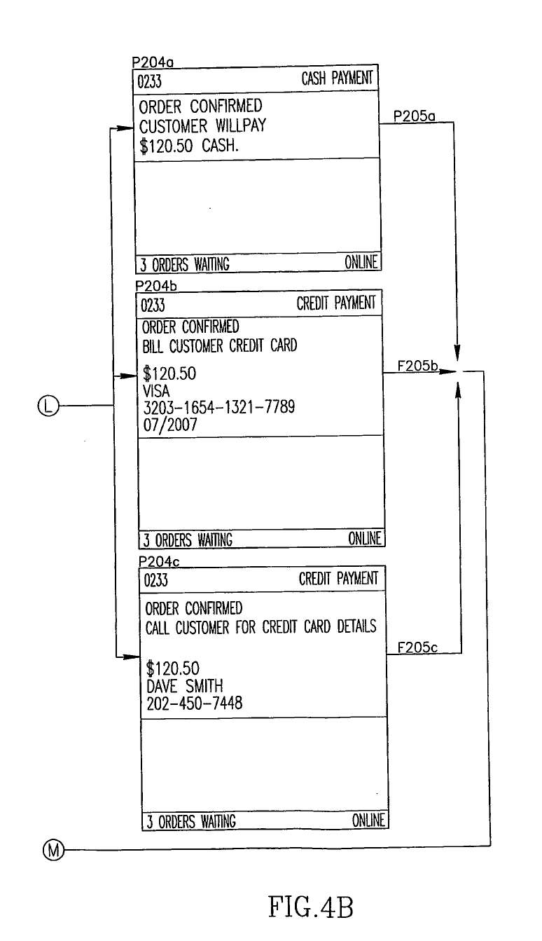

Reference is now made to FIGS. 3A, 3B and 4. FIGS. 3A and 3B are schematic flow chart illustration of an exemplary method for ordering goods using SMS-triggered cellular Internet menu, according to an embodiment of the present invention. FIG. 4 is a flow chart illustration of the method by which a merchant may service the order initiated by the customer according to FIGS. 1, 3A and 3B.

A customer (end user) wishing to order from a supplier, such as a restaurant, may send a SMS from his cellular phone (step S0001), with a single word (or other identifier) identifying the restaurant/merchant/catalog vendor to the system's service computer 16 (FIG. 1). The user's caller ID is recognized via this initiating SMS message.

A check is made if the restaurant is on file. If the user address is on file (query box Q001), a return SMS containing a URL (Uniform Resource Locator) with an embedded link in which an identifying code of the user's caller ID is also embedded (for user authentication purposes during the normally ‘anonymous’ cellular browsing).

The customer will then receive an URL in the return SMS, authenticating the identity of the customer (F016, F021, step S002). The SMS message may contain the user's id code embedded in an URL address for the restaurant menu and additionally may contain explanatory information. (steps F016, F021, F020).

If the customer is not registered, the customer may register his address with the service, either through voice contact or via his cell phone (steps S003, F019; F019B or P002). The newly registered user will receive a SMS containing his ID code embedded in an URL, authenticating the identity of the customer (steps B001; F020; step S004). similar to step S002, above.

Optionally, the server may initiate a query to determine if a user address on file is within range of the delivery zone for the specific restaurant (query box F020).

After authentication, a dialog between the end user and the system would take place to determine the delivery address for the order and the items being ordered. Delivery details are sent by the user to the restaurant (step P001), which returns its main menu (step P003) containing several section links. Clicking on any of the section links leads to a list of items which may be ordered (step F002/P004).

For example, step P001 allows the user to select from a series of options including home delivery, office delivery (both addresses being previously stored on the server), pick up and delivery to a new address (not being previously known to the server).

In the case of the latter selection, that is delivery to a new address or to a location not on file, a secondary dialog would take place between the user and the server steps P002, P002c and P002d, flow lines F022, 023, 024 and 025

Optionally, the server may initiate a query to determine the delivery zone for the specific restaurant or supplier (query box F022). If a restaurant selected does not deliver to the address requested, the user may receive a list of restaurants of the same type or category which do deliver to that area (steps P002c, P002d). Alternatively, the user may select a listing of restaurants of a different type step P002d).

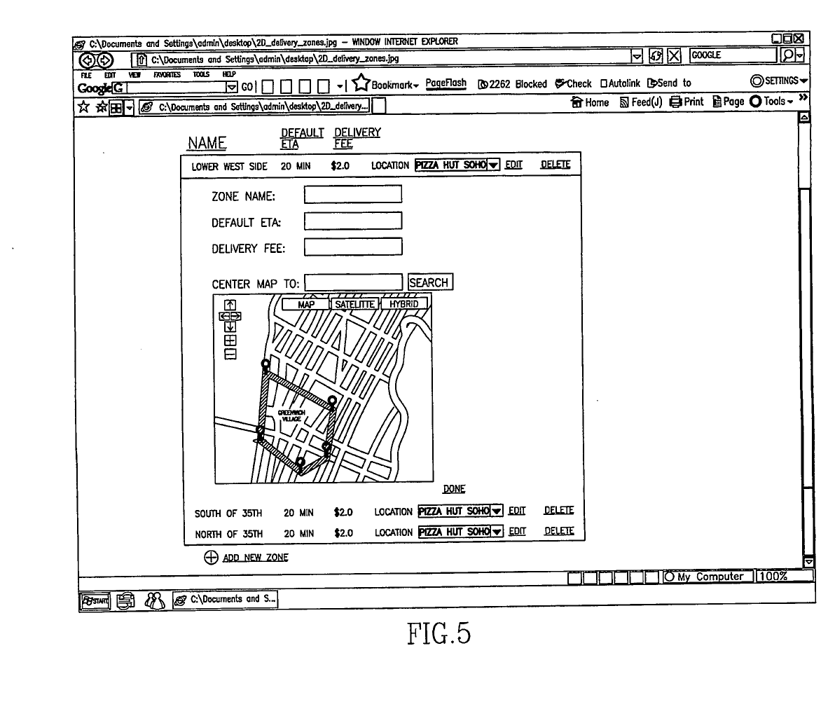

It will also be appreciated that the present invention may be extended to include variations and additional features associated with the method for ordering goods. For example, if a user requested delivery to a certain address rather than collection/pickup, during step P001, a cartographic type query may be made to a GIS system. The query could be of the format “is user's delivery address within range/delivery area of the restaurant?”, or if the restaurant forms part of a chain of restaurants: “which branch is closest to the customer?”. Further examples of GIS queries may include: “what is the closest branch to the users address? and “does this closest branch deliver to the users address?”. The boundaries of the delivery zones may be ‘pre-drawn’ as polygons on an electronic map to give the merchant a visual representation of the delivery area, as shown in FIG. 5, for example. A text-geo-coding process based on the address send by the user in his text message is converted by the service to coordinates.

Another option is for the user to initiate a request, and for the system to return a list of merchants/restaurants, located in the area from which the user operates his cell phone. In this case, a set of coordinates may be produced by either LBS service via cell companies or by GPS receiver on the user's handset. This location based query may be used to produce a list of merchants that deliver to the area “where user is now”. However, the exact address would need to be determined by user indicating it in text or by merchant call back to user's number.

To order, the user would select from the specific restaurant's menu, as described with reference to steps P003-P009. Briefly, the user may select items from a selection of items (P003; P004), optionally adding or removing items before checking out.

On checking out, the restaurant lists the items for payment (step P005) by any of several different methods including cash and credit, for example, (steps P005-P009). If the user's credit details are on file (query box Q002), the user may elect to pay by cash or credit (step P006 and query box Q003). If payment is by credit, the order and credit payment details would be confirmed by the restaurant (steps P008; P009).

If the user's credit details are not on file (query box Q002), the user may elect to pay by cash or credit (steps P005; P007). If payment is to be by credit, the user would receive a call from a representative in order to receive details of the credit payment. If user's credit card information is on file no call back is needed, and the credit card information would be securely passed for billing from Lingolines™ to the merchant.

The order (cash or credit) would be finally confirmed by the restaurant (step FIG. 4—P204a, P204b, P204c).

FIG. 4 illustrates the merchant's side of the operation for processing the order where payment is by cash or credit (steps P201-P204c). After the merchant completes handling the order, a confirmation message of the order may then be sent to the user listing the items ordered and the delivery address and expected delivery time, for example. Sample text messages which may be received by the user are shown in frames S005-S008. For example, a typical message for a delivered purchase paid by credit card is illustrated in frame S005, while a typical message for a purchase to be collected and paid for by cash is illustrated in frame 5008.

Reference is now made to FIG. 4, which illustrates sample information frames available to the merchant. Frame P201 is an exemplary main menu allowing the merchant to keep track of his inventory (stock chart), take orders and generally manage orders (order history), for example (frame P201). Frame P202 illustrates a typical order (described hereinabove with reference to FIGS. 3A-3B) received from a customer with delivery details. Frame P203 is a continuation of frame P202 in which the amount due may be entered if it is not automatically calculated, and an estimated time of arrival may be added.

Frame P204a, P204b and P204c display three alternatives typical confirmation screens. P204a displays a typical confirmation screen for a confirmed cash order and frames P204b and P204c displays a typical confirmation screen for credit order. P204c shows the confirmation screen with the contact details for a customer wishing to pay by credit, but whose credit card details were not previously known.

Reference is now made to FIGS. 6A-6I, which illustrates an exemplary web based wizard, which may be utilized by a merchant wishing to create an automatic service for use with the system of the present invention. In an exemplary application, described above, the merchant is a restaurant owner, who wishes to automate take-out ordering thus enabling higher business throughput, especially in peak lunch and dinner hours.

The restaurant owner logs onto the service company (such as “Lingolines™”) web site and registers as a merchant for the “take-out ordering service”. After filling in the wizard, the merchant receives a customized auto-produced graphical image by email along with instructions on how to add this image to his paper take-out menus (or any online menu also).

During the registration process the merchant creates a sample label. The merchant may also be able to buy or reserve a code word for their business and check if it's available or taken, this will be the merchant identifier used within the SMS message sent by users when ordering by text.

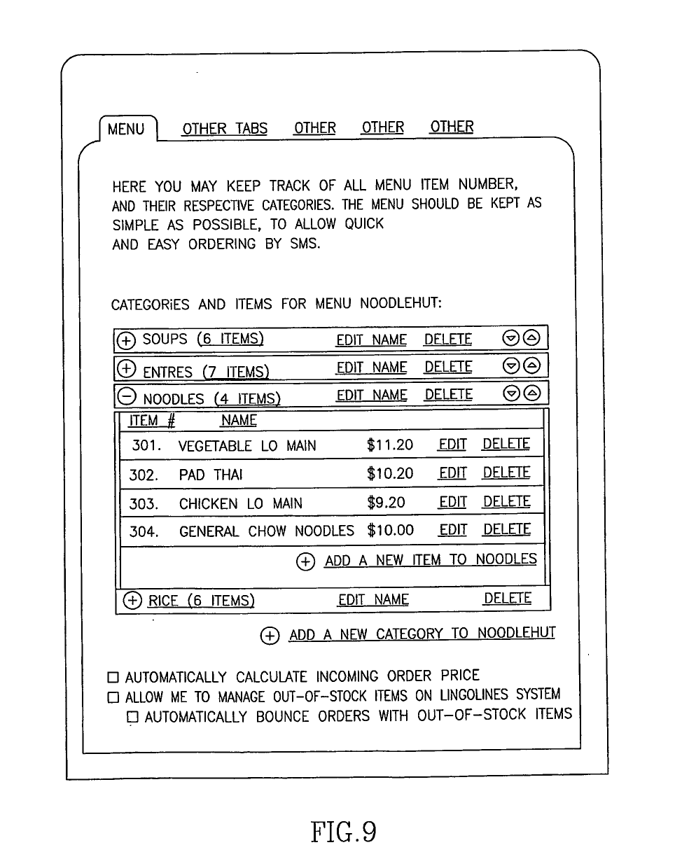

Any customer receiving the restaurant's menu in paper format (or via web) can now order food in a fully automated way (as described above with reference to FIGS. 1, 3A, 3B and 4)—and with remarkably shorter ordering time than any existing interfaces such as phone—voice/touch, web shopping cart, or fax, for example. FIGS. 3A and 3B would require merchant to also fill in a full menu (see FIG. 9).

FIG. 6A is an illustration of the initial page of the Lingolines™ merchant registration wizard, introducing the customized wizard. FIG. 6B allows the merchant to enter his name, restaurant ID and password. The ‘order box’ on right hand side of the page shows the effect of each input; the business name “burgerhut” appearing in the first box. In the following page, FIG. 6C allows the merchant to enter examples from his menu items together with their respective item number to be used on the customized explanatory label. The result of entering item 12 is shown in the order box representing the label in the making.

The merchant may then select the payment methods (for example, cash and credit card) he is willing to accept as well as the method of supply/delivery he operates. An example of a typical order for the exemplary merchant is shown in FIG. 6D, where there is a cash order for two items (12;15) for delivery to the customer's address pre-registered as “home”.

FIG. 6E allows the merchant to enter his preferred billing option together with his credit card details (if applicable). The next screen (FIG. 6F) allows the merchant to select the type of computer device which the merchant's would use to manage incoming orders. FIG. 6G is a page enabling the merchant's to enter his contact details and FIG. 6H contains the text of the user agreement between the service provider and the merchant. The final FIG. 6I of the wizard is the signing-off page.

It will be appreciated by persons knowledgeable in the art that the present invention is suitable for other vendors such as advertisers, government and municipal bodies and may be adapted for many applications. Non limiting examples include “Timed TV Commercial Call Back” (a television commercial ‘interactive back channel’ used by viewers for initiating call back by advertiser), “Auction bidding” (television/web), “Betting” (sports-television/web), “Pay bills”—(paper/government), “Movie” (buy ticket to a movie) and “Taxi”—(order a cab pickup).

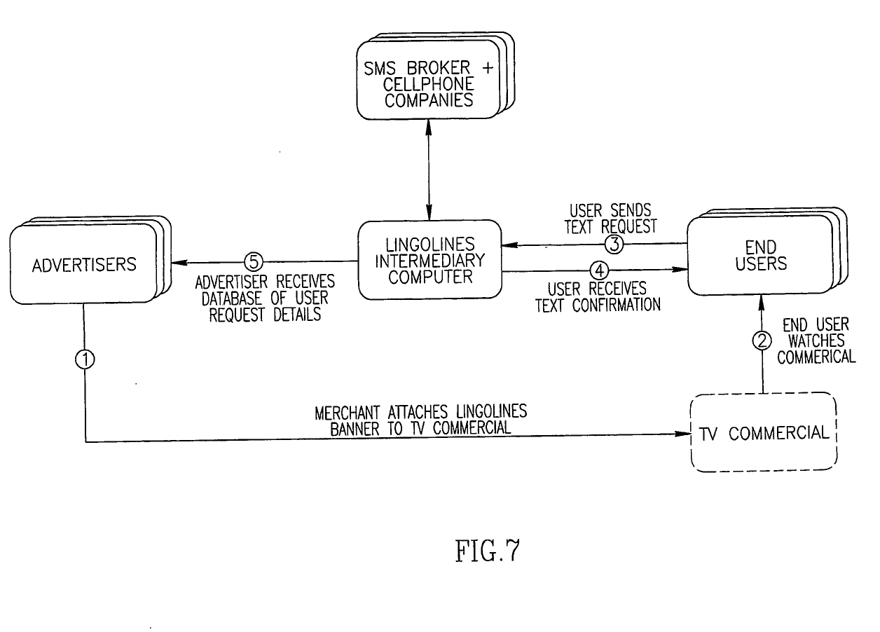

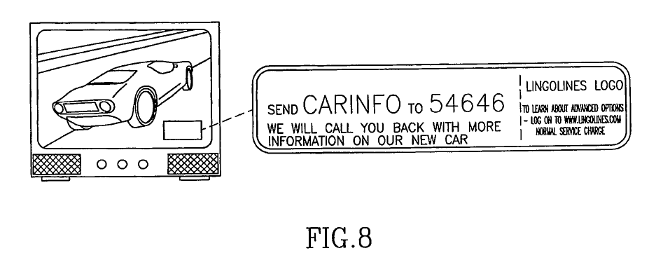

FIGS. 7 and 8 illustrate the use of the present invention for “Timed TV Commercial Call Back”. FIG. 7 is a flow chart illustration of a callback advertising application, according to an embodiment of the present invention and FIG. 8 is a sample of an advertising label appearing on a television advert.

User initiated, SMS Triggered Mobile Phone Internet Menus and Catalogs [FIG. 3a/3b]

In a further embodiment of the invention, a user who doesn't have a labeled SMS menu with numbered items list on it in front of him, may use his cell phone to order an item. In this application, the user may initiate an SMS query that returns either an interactive Mobile Internet based menu, which may be a copy of the restaurant menu used for ordering, a list of several menus that meet the search criteria or a list of several categories which the user can browse through and find what he is looking for.

In an exemplary application, a user may send a specific ‘word’ by SMS to the ‘Lingolines™’ service number. When the service company (such as “Lingolines™”) computer receives a single ‘word’ query, without a full “lingo-line” order following it, the computer may interpret the ‘word’ as a ‘search query’, and may generate a return text message to the user, with an embedded link in it, such as a WAP Push message or an SMS-link, for example. When the user opens the return message, and clicks the URL embedded in it, he will receive an updated menu in answer to his query.

For example, an end user may write the word “loop”, and in return get a reply SMS, with an embedded link to a mobile Internet menu for a restaurant called “loop”. He may then scroll through the restaurant's menu and place an order.

An SMS search may also use a generic term such as “sushi”. In this case, the return SMS which would be initiated may contain an embedded link to a mobile Internet based text menu, with links to several or all restaurant menus that serve sushi as one of their items. Thus, the user would obtain a link to a dynamically built mobile Internet menu, which when opened leads to specific restaurant menus.

FIG. 9, to which reference is now made, is an exemplary web based menu management interface of a restaurant menu or other catalog type, enabling merchants to actively self-manage (via a PC web browser) the menu database that will be used to create the interactive cellular menus for the end users ordering via cell phones. This management interface may include listing of the categories, such as soups, entrees, noodles, rice, for example and items (the types of noodles available, for example).

As will be appreciated by persons knowledgeable in the art, the interface is not limited and may also include special deals and prices, dish sizes for each item, cooking options (well done, medium, rare), for example. All of these options may also be shown in a typical SMS triggered Internet cellular menu used with the method of FIGS. 3A and 3B, described above.

This interface wizard may also create a WAP sticker/label (as illustrated in FIG. 2F), provided that the optional “full menu management” screen is filled out online by the merchant.

### Merchant Initiated, Promotional ‘SMS Links’

In yet another embodiment of the invention, merchants or restaurants may promote their ‘specials’ by sending out ‘active-SMS messages’, with the ‘special offer’ detailed as a ‘question’ as part of the text message. The ‘question’ may be an embedded link, which, when clicked on by end users, may lead to a Mobile Internet based menu so that the item on ‘special’ may be ordered with just one-click.

For example, a pizza merchant can send an SMS to its end users phrased as follows: “Large pizza and coke only 9$. Delivered to your home with one click! Buy now.”.

When users click on the embedded “Buy now” link, they may be led to an interactive menu that allows them to buy that item with one additional ‘approval click’. These may be personalized offers or generic offers. In this way, the merchant may initiate a promotional offer using SMS, and allow the end user to complete his order with minimum number of steps and little effort.

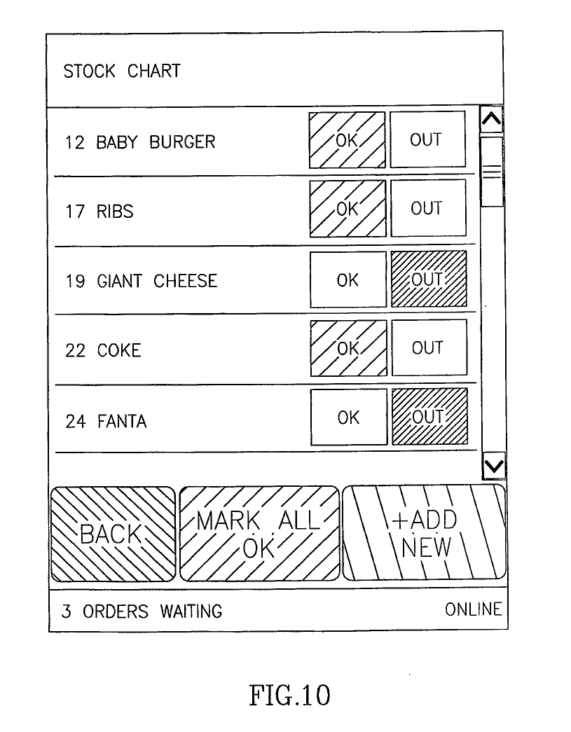

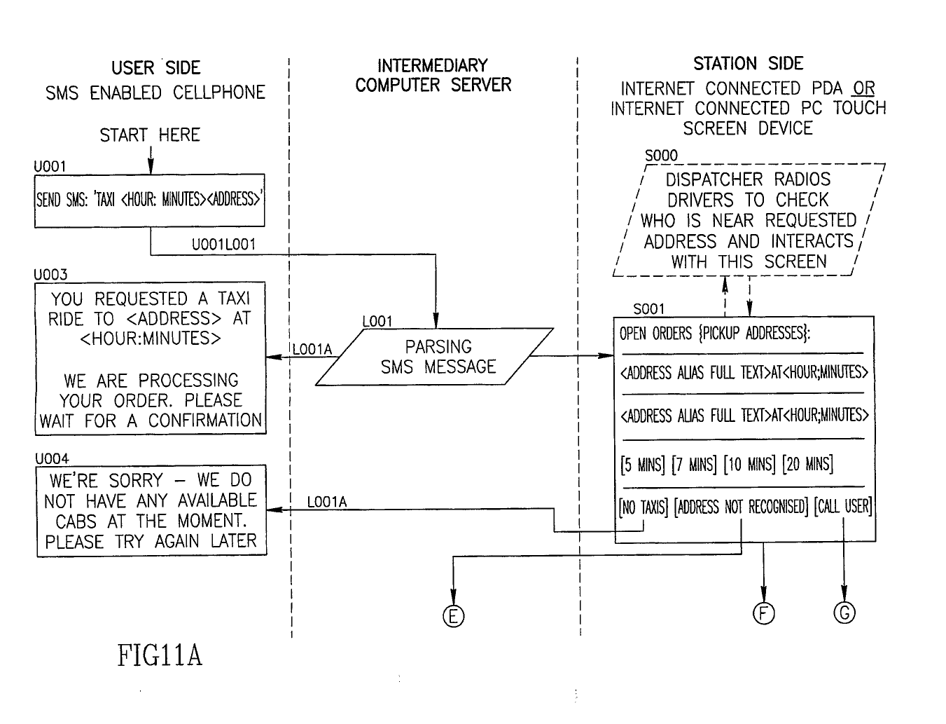

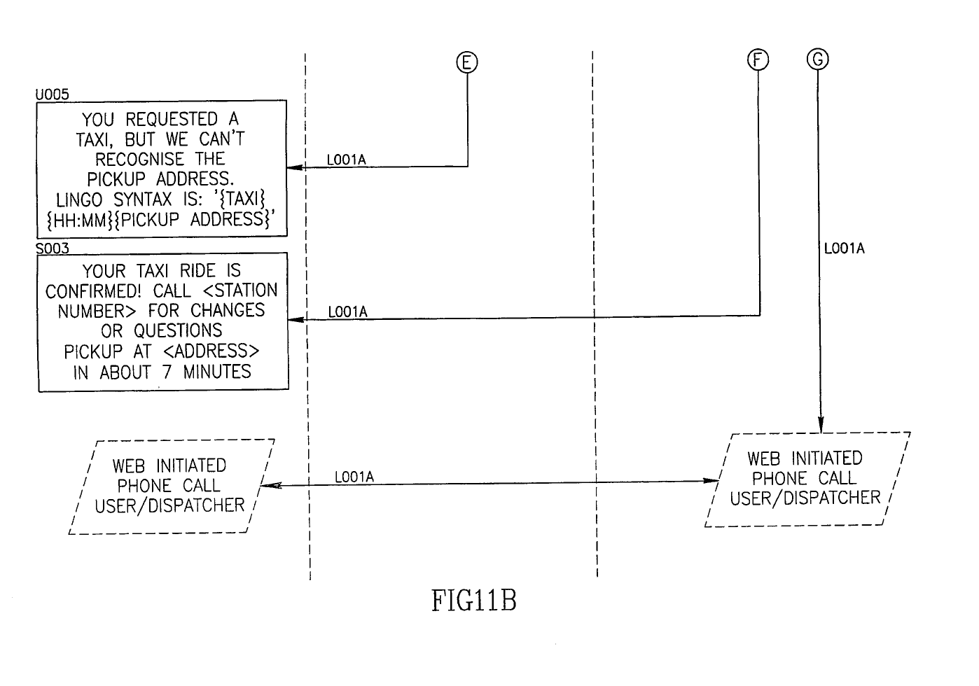

Out of stock items may be managed by the restaurant via restaurant-cashier Point-Of-Sale (POS) or PDA management interface (see FIG. 10) and if items marked “out of stock” by cashier, they will not show or will be “grayed out” (that is not selectable) on the end-users cell phone during the ordering process.

As will be appreciated by persons knowledgeable in the art, the method and system described above is not limited to the restaurant business but maybe adapted to other businesses. For example, a simple coded SMS message may be sent to a taxi firm via the intermediary computer which routes the message to the firm.

### SMS Triggered Mobile Phone Internet Taxi Ordering

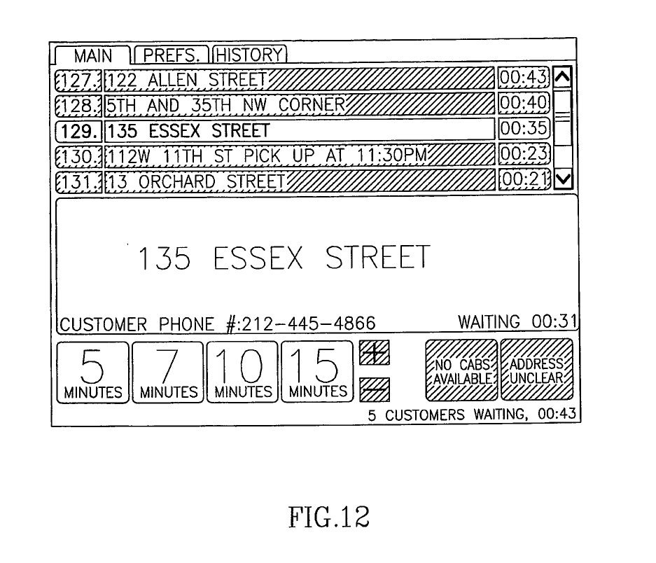

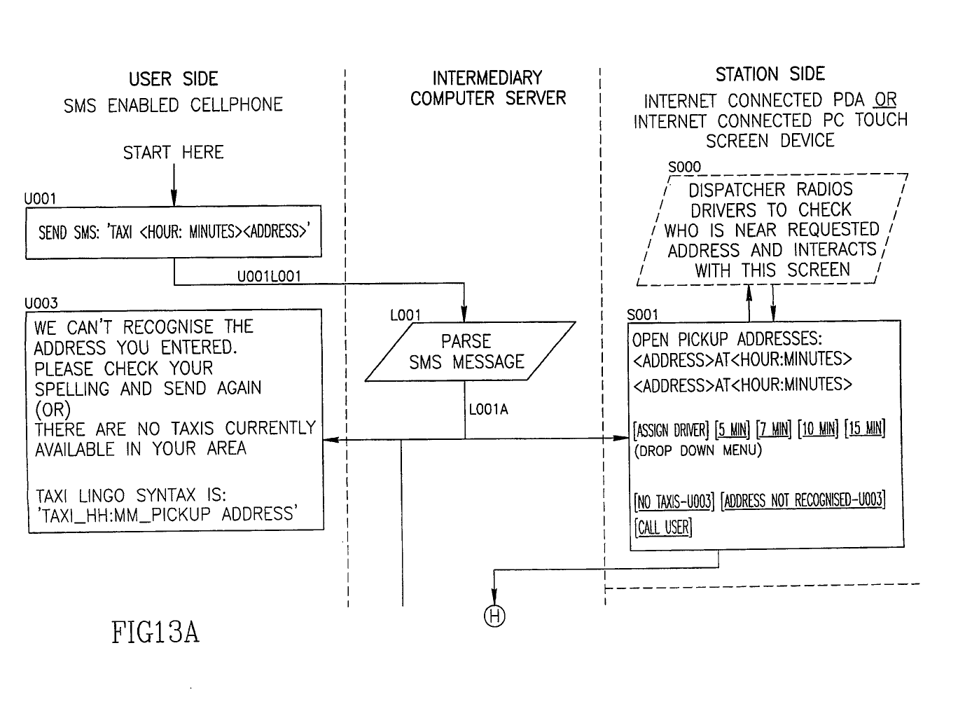

Reference is now made to FIGS. 11-14. FIG. 11 illustrates a method for ordering a taxi via SMS, in accordance with an embodiment of the present invention, known as “simple station’. FIG. 12 is a visual display of a touch screen for use by a taxi station with the embodiment of FIG. 11. The screen example is the ‘station side touch screen’.

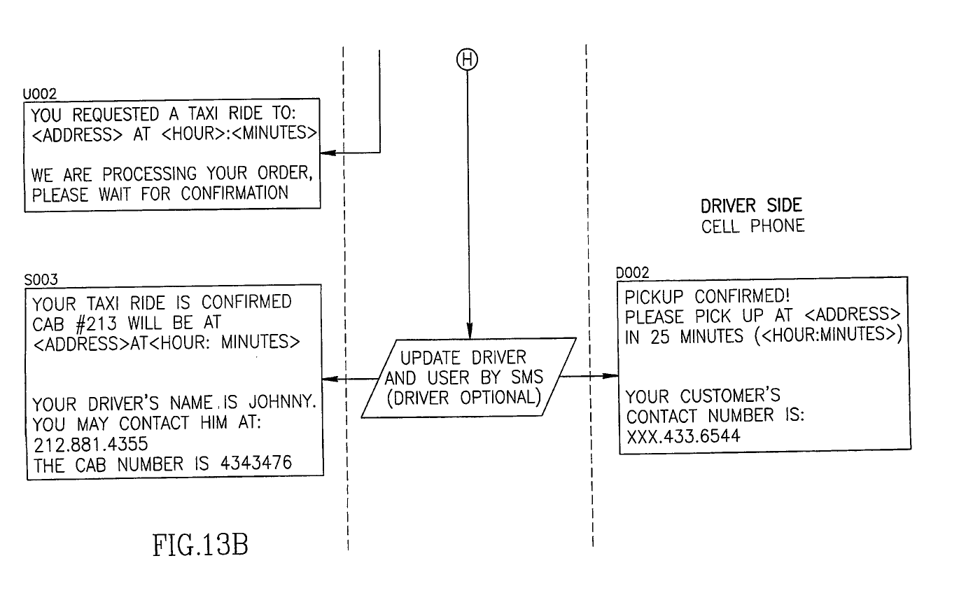

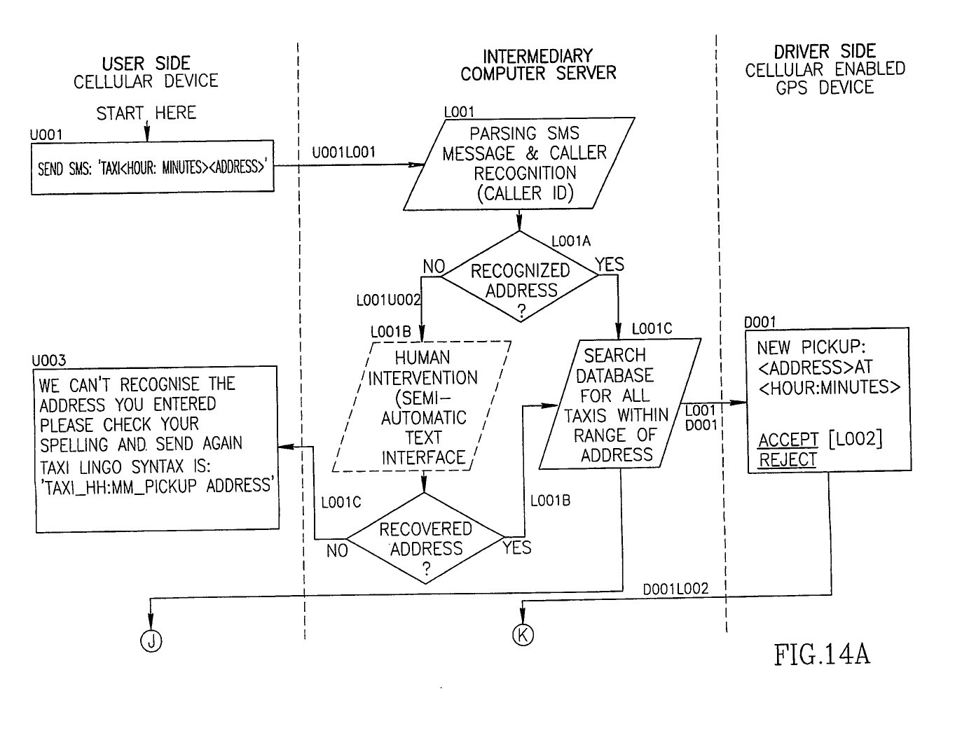

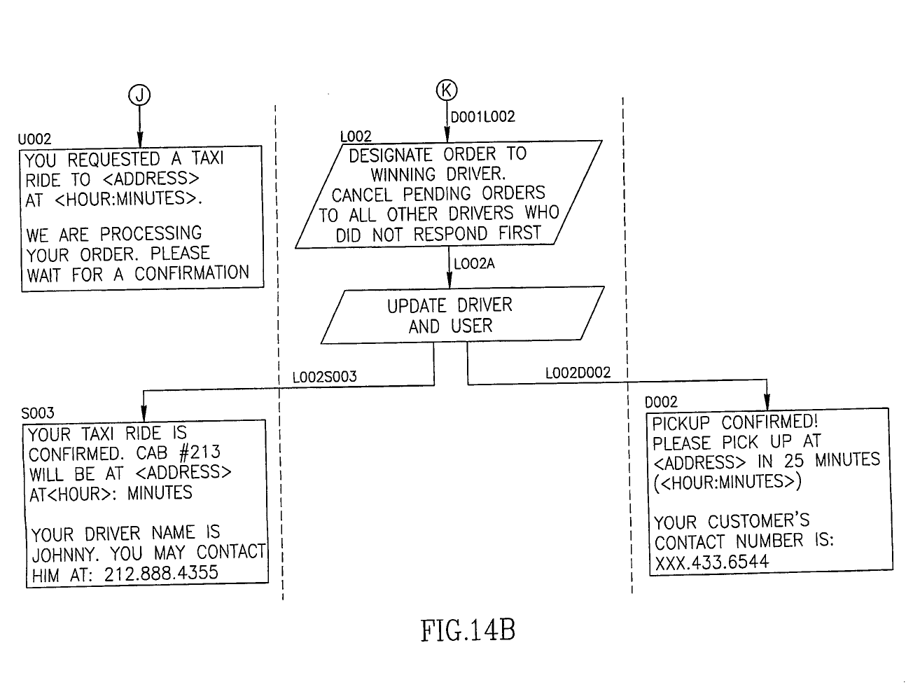

FIG. 13 illustrates a method for ordering a taxi via SMS, in accordance with an embodiment of the present invention, known as “fast station’. FIG. 14 illustrates a method for ordering a taxi via SMS, in accordance with an embodiment of the present invention, known as “virtual taxi dispatch”.

The methods in each embodiment are similar. Reference is now made to the “simple station” embodiment of FIG. 11, which is a flow chart illustration of the method for ordering a taxi. The Lingolines™ server acts as the intermediary and is in communication with both the user and the taxi station.

To order a taxi, the user sends a SMS message to the taxi (cab) company which includes basic information needed to order a taxi and may be of the format ‘taxi<hour: minute><address>” (step U001). The time field is optional—if it is not included by the user, the system assumes that the order is for a taxi as soon as possible.

The message is received by the ‘Lingolines™” server, parsed (step L001) and sent to the taxi station. The ‘Lingolines™” server also confirms receipt of the request (step U003).

The taxi station processes the order (S001) and may contact their drivers in order to ascertain which taxi is in the vicinity (S000). The station then advises the user by SMS initiated via the intermediary computer and web based device on station side whether and when a cab will be available. If the order is confirmed, the station sends a confirmation SMS via intermediary computer to the user (S003). If the order cannot be confirmed, the station advises the user accordingly (steps U004, U005).

As shown in FIG. 12, the taxi station may use a visual display touch screen to display the incoming orders, with details of the users. For example, SMS number 129 received at 00:35 is for a pick-up from 135 Essex Street. The customer's phone number is listed together with the order wait time.

Reference is now made to FIG. 13 which is a flow chart illustration of the method for ordering a taxi, known as “fast station’. The Lingolines™ server acts as the intermediary and is in communication with both the user and the taxi station.

The method is similar to the method of FIG. 11. To order a taxi, the user sends a SMS message to the taxi (cab) company which includes basic information needed to order a taxi and may be of the format ‘taxi <hour: minute><address>” (step U001). The message is received by the ‘Lingolines™” server, parsed (step L001) and sent to the taxi station. The ‘Lingolines™” server also confirms receipt of the request (step U002).

Alternatively, the user may receive an error message indicating that there is a mistake in the taxi lingo syntax (frame U0003).

The taxi station processes the order (S001) and may contact their drivers in order to ascertain which taxi is in the vicinity (S000).

The station then advises the user by SMS via the intermediary computer whether and when a cab will be available. If the order is confirmed, the station sends via the intermediary computer a confirmation SMS to the user (S003). If the order cannot be confirmed, the station advises the user accordingly (steps U004).

In the “fast station” embodiment, the station may update the driver by sending an SMS to the driver's cell phone via the intermediary computer, after selecting a driver from a drop down menu, for example (step D002)

Reference is now made to FIG. 14, which illustrates a method for ordering a taxi via SMS, in accordance with an embodiment of the present invention, known as “virtual taxi dispatch”. In this embodiment, the Lingolines™ server acts as the intermediary and is in communication with the user and directly with the taxi drivers whom may be equipped with devices that constantly (every 15 seconds, for example) report their present location via IP based cellular communications that may pinpoint the location based on either LBS or GPS technology.

To order a taxi, the user sends a SMS message to the taxi driver which includes basic information needed to order a taxi and may be of the format ‘taxi <hour: minute><address>” (step U001). The message is received by the ‘Lingolines™” server, parsed (step L001).

If the address is recognized via an automatic geo-coding process (performed via external web service such as Google Maps™ geo-coder API), the server searches its database for all taxis within range (query box L001C). The ‘Lingolines™” server confirms receipt of the request (step U002) and notifies driver, having an enabled GPS device (for example) that a taxi is requested (step D001).

If a driver responds and accepts the order, the order is designated to that driver and the request to any other drivers cancelled (step L002). The server then updates the driver and the user by sending a confirmation SMS to the user (S003) and a confirmation of pick-up, with the customer's contact details to the driver (D002), and an optional GPS ‘object’ with target address sent to the driver guiding him to the user location via his standard GPS

If the address is not recognized (query box L001C) by the ‘Lingolines™” server, the address may be checked by human intervention (step L001B) and if the address is corrected, the server searches its database for all taxis within range (query box L001D) and carries out the steps outlined above for a confirmed pick-up. If, despite human intervention, an address is not found, the user may receive an error message indicating that there is a mistake in the taxi lingo syntax (frame U0003), and more specifically that the address hasn't been recognized.

If the user is registered with ‘Lingolines™’, and his caller I.D. is registered on file, he may use predefined aliases for address (@home, @office etc), instead of typing the entire address in the text message. The system will recognize this automatically, and give the ‘full address’ on the other side.

The examples of syntax used in the SMS messaging are non-restrictive examples. For example, the syntax may also include a “to field”, that is the user may indicate “taxi @home to Brooklyn” or “taxi 10:30 from 234 Lexington Ave to long island”. The syntax may also use ‘in xx-minutes’ instead of time: “tax 23 min @home” for example. The time may be either in am/pm or in 24 hour format

It will be appreciated that many additions and variations may be to the invention. For example, a GIS system may be connected to the drivers cab, thus enabling driver to get automatic directions to pickup address without manually entering it—when a taxi receives a ‘recognized’ pickup address (in the virtual dispatch of FIG. 14).

If a certain pickup is scheduled for “a later hour”, when driver accepts it, he may set a ‘pickup reminder’ with one click, and then system will notify him x minutes before actual pickup should occur. Notification may be by SMS, or if he has an Internet device, by pop up in his receiving device.

Billing may occur by any known system such as reverse billing (through cell operators), and/or directly from merchant, on a per order basis, charged by monthly bills.

It will also be appreciated that the present invention is not limited by what has been described hereinabove and that numerous modifications, all of which fall within the scope of the present invention, exist.

Rather the scope of the invention is defined by the claims, which follow:

1. A method for ordering goods, comprising the steps of:
an end user sending a coded SMS (Short Messaging System) message from a cellular device to an intermediary computer;
the intermediary computer configured to identify the supplier of goods being ordered from the coded SMS message; and
the intermediary computer routing the received message to the identified supplier of goods.

2. The method according to claim 1, wherein said coded SMS message includes an identifier identifying the supplier of goods to whom the message is directed.

3. The method according to claim 1, wherein said coded SMS message further includes at least one unique identifier, said at least one unique identifier identifying a specific item being ordered.

4. The method according to claim 1, wherein said coded SMS message further includes at least one of a group of identifiers including a menu or catalog identifier code, identifiers to identify the method of payment, method of delivery, the customer's dietary constraints and additional text information.

5. The method according to claim 1, wherein said supplier of goods is a restaurant and the goods being ordered comprise a list of menu items.

6. The method according to claim 1, further comprising the steps of:
the intermediary computer recognizing the sender of the coded SMS message; and
if the supplier of goods is known to the intermediary computer, sending a return SMS message to the sender containing a URL (Uniform Resource Locator) with an embedded link in which an identifying code of the user's caller ID is also embedded.

7. The method according to claim 1, further comprising the steps of:
registering the end user; and
the intermediary computer authenticating the identity of the end user and sending a SMS containing an ID code embedded in an URL, to the end user.

8. The method according to claim 6, further comprising the steps of
the intermediary computer opening a WAP or web session with the end user containing a list of options for receiving the goods being ordered including at least one delivery address previously registered by the intermediary computer, option of entering at least one new delivery address and option of picking up the ordered goods; and
advising the supplier of goods of the delivery option selected.

9. The method according to claim 8, further comprising the steps of:
the supplier of goods opens a WAP/web session comprising at least one item which may be ordered from a selection of items in at least one menu; and
the end user ordering said at least one item from the supplier of goods.

10. The method according to claim 9, further comprising the steps of:
the end user adding to, deleting or replacing items being ordered;
selecting a method of payment from one of a group of methods including payment by cash and payment by credit; and
said supplier of goods processing the order and confirming the order and delivery details to the end user by SMS message to the end user.

11. The method according to claim 8, further comprising the step of:
the intermediary computer initiating a query to determine if the user address falls within the delivery zone for the specific restaurant.

12. The method according to claim 11, further comprising the step of:
if the supplier of goods selected does not deliver to the address requested, the intermediary computer advising the end user of alternative suppliers of goods who do deliver to the address selected.

13. The method according to claim 11, further comprising the step of:
making a cartographic type query to the supplier of goods via a GIS system to determine the delivery zone of the supplier of goods.

14. The method according to claim 10, wherein said confirmation includes an indication of the delivery time.

15. The method according to claim 1, wherein said supplier of goods is one of a group taxi services including a taxi dispatcher and at least one taxi driver, and the goods being ordered comprise a request for a taxi.

16. The method according to claim 15, wherein said coded SMS message is further configured to include an identifier identifying the address and the time of the requested taxi ride.

17. The method according to claim 16, further comprising the steps of
the intermediary computer searching a database to determine which taxis are within range of the address;
broadcasting a message to said taxis within range of the address, said message containing the address and time of the requested taxi pick up; and
confirming the order to the taxi accepting the taxi pick up.

18. The method according to claim 16, further comprising the step of:
advising the end user of the time of the pick up and the contact details of the driver.

19. A system for ordering goods via a cellular phone, comprising:
at least one cellular device for sending a coded SMS (Short Messaging System) message; and
an intermediary computer which receives the message and routes the received message to a supplier of goods,
wherein said coded SMS message is configured to include at least one of group of identifiers comprising an identifier for identifying the supplier of goods to whom the message is directed.

20. The system according to claim 19, wherein said coded SMS message is further configured to include at least one unique identifier, said at least one unique identifier identifying a specific item being ordered.

21. The system according to claim 19, wherein said coded SMS message is further configured to include at least one of a group of identifiers including a menu or catalog identifier code, identifiers to identify the method of payment, method of delivery, the customer's dietary constraints and additional free text information.

22. The system according to claim 19, wherein said supplier of goods is a restaurant and the goods being ordered comprise a list of menu items.

23. The system according to claim 19, wherein said intermediary computer is configured to append additional details to the routed message,
wherein said additional details comprises at least one of a group including the contact details of the message initiator and order number assigned by the intermediary computer.

24. The system according to claim 19, wherein the received message is sent to the merchant to one of group of devices including a PC or PDA, via an interne capable dedicated application, by fax, SMS message to a cellular device and email.

25. The system according to claim 19, wherein said supplier of goods is one of a group taxi services including a taxi dispatcher and at least one taxi driver, and the goods being ordered comprise a request for a taxi.

26. The system according to claim 25, wherein said coded SMS message is further configured to include an identifier identifying the address and the time of the requested taxi ride.

27. The system according to claim 26, wherein said intermediary computer further comprises a database containing details of taxi cabs, and wherein said intermediary computer is configured to broadcast a message to taxis within range of said address, said message containing the address and time of the requested taxi pick up; and wherein said intermediary computer is configured to confirm the order to the taxi accepting the taxi pick up.

28. The system according to claim 26, wherein said intermediary computer is configured to advise the end user of the time of the pick up and the contact details of the driver.

29. A method for supplying goods and services, comprising the steps of:
assigning an identifier identifying the supplier of goods and services;
creating a syntax for use with SMS (Short Messaging System) said syntax comprising at least said supplier identifier; and
an end user ordering at least one item utilizing said syntax via a SMS message to the supplier of goods.

30. The method according to claim 29, further comprising the steps of:
assigning a unique code for each of a group of items being offered for sale by said supplier; and
wherein said syntax comprises at least one unique item code associated with said supplier.

31. The method according to claim 29, further comprising the steps of:
assigning payment identifiers to identify the method of payment and delivery identifiers to identify the method of delivery; and
wherein said syntax further comprises one of said payment identifiers and one of said delivery identifiers.

32. The method according to claim 29, further comprising the step of:
the supplier sending a SMS message to an end user, said SMS message comprising at least the syntax for ordering from the supplier.

33. The method according to claim 31, wherein said payment identifiers comprise any of a group of methods including payment by cash and payment by credit.

34. The method according to claim 31, further comprising the step of:
said supplier processing the order and confirming the order and delivery details to the end user by SMS message to the end user via an intermediary computer.

35. A method for supplying goods and services, comprising the steps of:
a merchant registering with an intermediary computer, said intermediary computer being in communication with a plurality of end users; and
preparing a customized explanatory label comprising at least an identifier identifying the merchant, at least one item being supplied by the merchant and an identifier for said at least one item.

36. The method according to claim 35, wherein said customized explanatory label further comprises an indication of the payment methods accepted by the merchant, said payment methods comprising any of a group including payment by credit card and cash.

37. The method according to claim 35, wherein said customized explanatory label further comprises an indication of the type of delivery and collection available.

38. The method according to claim 35, further comprising the step of:
the merchant selecting a method of being billed by the intermediary computer, said method comprising one of group of methods including payment by credit card, check and paypal™.

39. The method according to claim 37, wherein the delivery location comprises a coded field indicating a pre-registered address.

40. The method according to claim 35, wherein said step of registering comprising the steps of:
entering the merchant's name, merchant identifying code and password; and
entering the merchant's contact details.

41. The method according to claim 40, wherein said step of registering further comprises the step of
entering the type of computer device used by the merchant for managing incoming orders.
